(19) United States
(12) Patent Application Publication
(10) Pub. No.: US 2021/0117897 A1
(43) Pub. Date: Apr. 22, 2021

(54) Road Condition Monitoring System

(71) Applicant: Collision Control Communications, Inc., Fort Wayne, IN (US)

(72) Inventor: Jeffrey Williams, New Haven, IN (US)

(73) Assignee: Collision Control Communications, Inc., Fort Wayne, IN (US)

(21) Appl. No.: 17/069,152

(22) Filed: Oct. 13, 2020

Related U.S. Application Data
(60) Provisional application No. 62/924,129, filed on Oct. 21, 2019.

(51) Int. Cl. G06Q 10/06; G08G 1/087; G01S 19/47; G06Q 50/26; G06Q 10/10; G06Q 30/02; G06Q 10/00; B60W 40/06

(52) U.S. Cl. CPC G06Q 10/06375; G08G 1/087; G01S 19/47; G06Q 50/26; G06Q 10/10; B60W 2552/35; G06Q 10/20; G06Q 30/0206; G06Q 10/06395; B60W 40/06; G06Q 30/0205

(57) ABSTRACT

A vehicle has a traffic light preemption system with a GPS receiver and an Inertial Measurement Unit (IMU). A processor is configured to log GPS data in correlation with IMU data, and to detect and map road surface defects. The processor may be configured to identify and report unmapped roads, and to correlate the road surface defects with traffic load, road construction type, and/or environmental factors. The processor may also be configured to detect and monitor changes in the IMU data associated with a given road surface defect, and/or road surface changes precursor to the development of road surface defects. The processor may be further configured to correlate the effectiveness of repairs to road surface defects with traffic load, road construction type, repair type, repairing entity, and/or environmental factors.

### CROSS-REFERENCE TO RELATED APPLICATIONS

The present application claims priority to U.S. Provisional No. 62/924,129, filed Oct. 21, 2019, the entire contents of all of which are herein incorporated by reference.

### BACKGROUND

### Field of Invention

Embodiments of the present invention described herein generally relate to a system installed at least on part on a vehicle for monitoring the condition of roads. The system gathers information pertaining to potholes, bumps, cracks, or other anomalies in roads, and their development, severity, rate of occurrence, and correlating factors. The system is further capable of evaluating the quality and effectiveness of repairs thereto.

### Related Art

Roads traversed by road-going vehicles are known to suffer deleterious effects from wear and tear, deicing chemicals, and weather, particularly freeze thaw cycles. These deleterious effects include the development of potholes, roughness, bumps, cracks, and other anomalies, which are unpleasant to drive over and can be damaging to the vehicles that drive over them. Furthermore, many of these anomalies are progressive and self-perpetuating in their development. For example, small potholes develop into large potholes in part due to the impact of vehicle wheels dropping into them, and further in part due to hydrodynamic effects that occur when the wheels splash through water standing in the potholes. Similarly, small cracks develop into larger cracks in part due to water penetrating the road surface through the small cracks and subsequently freezing or softening the ground underneath. Bumps, roughness, and other anomalies often develop as a result of substandard repairs and/or interactions between vehicle suspensions and the road surface.

Often, due to the sheer mileage of roads that must be maintained, parties responsible for their repair are unaware of the development of potholes, roughness, bumps, cracks, and other anomalies. In order to address this, it is known to use vehicle event recorders on vehicles to detect such anomalies. Known vehicle event recorders may include sensors, video recorders, audio recorders, accelerometers, gyroscopes, vehicle state sensors, and/or global positioning system (GPS). Known systems may store sensor data associated with the potholes, such as location data, video data, audio data, accelerometer data, gyroscope data, vehicle type data, vehicle state sensor data, GPS data, outdoor temperature sensor data, moisture sensor data, and/or laser line tracker sensor data. Known vehicle state sensor data may be provided by a speedometer, an accelerator pedal sensor, a brake pedal sensor, an engine revolutions per minute (RPM) sensor, an engine temperature sensor, a headlight sensor, an airbag deployment sensor, driver and passenger seat weight sensors, an anti-locking brake sensor, an engine exhaust sensor, a gear position sensor, and/or a cabin equipment operation sensor.

Known systems may analyze sensor data to determine if the data shows the existence of a pothole according to pothole definitions. Known pothole definitions may be based on a minimum and maximum sensor data threshold and may depend on a vehicle weight, vehicle type, and/or vehicle speed. Known pothole classifications may be based on pothole severity, pothole visibility, pothole difficulty to avoid, and/or pothole event occurrence rate. Known systems may add a pothole indication to a pothole map that indicates pothole map related information such as pothole severity and frequency, and may further provide a pothole video.

Known systems are typically standalone systems, requiring their own separate sensors with the associated expense and manufacturing complexity. Further, known systems are generally reactive in nature, recording only potholes, cracks, and bumps after they develop, and are unable to make any further correlation between the potholes, cracks, and bumps, factors affecting their development, progression, and repair. Nor do known systems create meaningful data regarding the overall maintenance of a road network, beyond the existence and number of potholes, cracks, and bumps. Accordingly, there is an unmet need for a road condition monitoring system that integrates with existing vehicle systems, as well as a system that provides more meaningful information regarding the development, progression, and repair of road networks.

### SUMMARY

Embodiments described herein relate to a Road Condition Monitoring System. An embodiment of the Road Condition Monitoring System may be implemented by one or more processors, and may work in conjunction with, for non-limiting example, a traffic light preemption system. The exemplary traffic light preemption system is used by emergency vehicles to preempt traffic lights, or in other words to give priority to the emergency vehicle to enable it to travel more quickly to a destination. As part of its function, the exemplary traffic light preemption system alters the traffic light sequence in advance of the arrival of the emergency vehicle, so that other traffic is provided sufficient time to clear the intersection. In order to do this, the exemplary traffic light preemption system is provided with a Global Positioning System (GPS) receiver, so that the system knows the location, direction of travel, and speed of the emergency vehicle.

As a backup to the GPS receiver, the exemplary traffic light preemption system is further provided with an Inertial Measurement Unit (IMU). The IMU provides acceleration information that may be used by the exemplary traffic light preemption system to calculate vehicle position based a last known GPS position, heading, and speed, i.e.—by way of dead reckoning. In this way, the exemplary traffic light preemption system can still accurately preempt traffic lights based on the position, direction, and speed of the emergency vehicle even when GPS function is lost. The exemplary traffic light preemption system logs data provided by the IMU, for non-limiting example every half second, for this purpose. Furthermore, the IMU data may be logged along with GPS data in real time, such that for each row of data logged by the IMU, the exemplary traffic light preemption system also logs the GPS coordinates and other data such as speed and heading. Compass heading may also be provided by a magnetometer and logged as an additional backup.

The IMU data can also be used by the Road Condition Monitoring System to detect and map road conditions, particularly road surface defects such as potholes, bumps, cracks, or other anomalies. For example the IMU accelerometer z-axis will register higher and/or lower when going over a pothole, bump, crack, or other anomaly in the road. Typically but not always, these events register both a high and low z-axis data point. For example, a bump may register an increase followed by a decrease, whereas a pothole may register a decrease followed by an increase. Embodiments of the Road Condition Monitoring System may also monitor and log brief x and y axis movements and/or accelerations for indications of potholes, bumps, cracks, and other anomalies. By logging these events and correlating them to the logged GPS data and with the other logged IMU data and/or magnetometer data, the Road Condition Monitoring System is able to overlay indications of the potholes, bumps, cracks, and other anomalies on a map. For non-limiting example, an embodiment of the Road Condition Monitoring System may show the events overlaid on a mapping application such as Google Maps or Google Waze. The Road Condition Monitoring System may further calculate the total miles of roads surveyed in this way, and may further notate any roads that have not been so traversed and mapped. The Road Condition Monitoring System may then notify vehicles equipped therewith of roads that require mapping, so that such vehicles may traverse unmapped roads if otherwise convenient.

Further, an embodiment of the Road Condition Monitoring System may sort the events and/or give an indication of their severity on the map overlay, and/or may provide information concerning them to interested parties, such as city, county, or state Departments of Transportation (DOT). An embodiment of the Road Condition Monitoring System may further correlate the events, their severity, and/or their frequency to factors such as traffic load, road construction type, and/or environmental factors, as non-limiting examples. The Road Condition Monitoring System may set minimum and/or maximum thresholds of severity of the events to be reported and/or displayed. Moreover, an embodiment of the Road Condition Monitoring System may detect and monitor changes in the data received from the IMU when the emergency vehicle repeatedly traverses a given pothole, bump, crack, or other anomaly in the road. In this way, the Road Condition Monitoring System may monitor the progression or development of the pothole, bump, crack, or other anomaly. It is here noted that embodiments of the Road Condition Monitoring System may be provided with one or more learning algorithms that allow it to, for non-limiting example, to compensate for vehicle type, vehicle suspension, and/or other vehicle characteristics.

Additionally, the Road Condition Monitoring System is able to monitor road surfaces for changes that may occur prior to the development of an actual pothole, bump, crack, or other anomaly, and is able to predict the occurrence of a pothole, bump, crack, or other anomaly before it develops. This prediction may be based at least in part on known industry data concerning road construction and known industry data concerning road deterioration, as well as patterns of specific local data concerning road construction and deterioration. A non-limiting example of known industry data concerning road deterioration is provided by the Paser Asphalt Roads Manual by Donald Walker, Wisconsin Transportation Information Center, University of Wisconsin-Madison, © 1987, 1989, 2002, the entire contents of which are hereby incorporated by reference. Similarly, patterns of specific local data concerning road construction and deterioration may include information such as that presented by the Paser reference, except that such information would be adjusted to local conditions. For further non-limiting example, the Road Condition Monitoring System may detect the development of alligator cracking, followed by the development of a depression in the road surface, and may thereby predict the development of a pothole and/or its severity. The Road Condition Monitoring System may then overlay these predicted potholes, bumps, cracks, and other anomalies on the map, and/or provide information concerning their predicted characteristics to interested parties. Such predicted characteristics may include severity, rapidity of development, frequency, location within the lane, and etcetera.

The Road Condition Monitoring System may also monitor the repair of potholes, bumps, cracks, and other anomalies. For example, once repair of a pothole, bump, crack, or other anomaly has been ordered, the Road Condition Monitoring System may provide to interested parties verification that the repair has taken place. The Road Condition Monitoring System may also determine the immediate and long-term quality of the repair by way of event data from the IMU at the repaired location, and may correlate it to data concerning the road construction, traffic, environment, weather and/or season, as well as to repair type, repair person or crew, company, and/or contractor. To illustrate, if a given crew repairs a pothole or crack using a cold-pack asphalt material, it is expected that the repair material will settle over time, so that the repair crew will often overfill the pothole or crack. How long that takes and the quality of the final state of repair may depend on the initial road construction, traffic, the weather, and how well the repair crew positioned the fill material at the time of repair. The Road Condition Monitoring System then provides the information regarding the quality of the repair and correlating factors to the interested parties.

Aside from identifying individual potholes, bumps, cracks, and other anomalies, the Road Condition Monitoring System may be provided with an algorithm that determines which roads have the highest frequency of events per mile and similar metrics. In this way, the Road Condition Monitoring System may help a city, county, or state DOT determine where funds may be best applied to repair roads, including what types of repairs are needed such as simply filling potholes versus affecting a complete grind and/or resurface. Further to this, the Road Condition Monitoring System may provide inputs that allow the city, county, or state DOT to enter, for non-limiting example, a total budget, the cost per one hundred feet per lane to repave a road, the cost per pothole for manual repair, traffic estimates for each road (or at least traffic estimates for main roads), and etcetera. In this way, the Road Condition Monitoring System is able to calculate costs and recommend at least one repair strategy concerning how and where the city, county, or state DOT may best spend its funds.

Embodiments of the Road Condition Monitoring System may display the mapped event data online so that the general public can see it. Often municipalities ask citizens to report potholes. By showing the mapped event data online, embodiments of the Road Condition Monitoring System allow citizens to see that a given reported pothole location is in the system. Further, by showing the mapped event data online, embodiments of the Road Condition Monitoring System allow citizens to see what roads have or have not been mapped, and whether events have been reported. Further embodiments of the Road Condition Monitoring System may record a video of the road while gathering event data, which recorded video may include the entire road or only segments containing potholes, bumps, cracks, and other anomalies. The recorded video or videos may be synched to the event data with respect to location and time, so that the video showing the pothole, bump, crack, or other anomaly can be linked to the mapped event data online.

Embodiments of the Road Condition Monitoring System may also determine whether roads are snow covered by way of comparing reported IMU data with existing IMU data for a given road surface and determining if the IMU data is altered in such a way as to indicate the presence of snow. The IMU data indicating the presence of snow may be used by embodiments of the Road Condition Monitoring System to compare snow plow methods, and/or the effectiveness of given snow plow drivers and/or snow plow equipment. As with previously described embodiments, the snow related data provided by the Road Condition Monitoring System may also be displayed online so that the public is notified when city roads have been plowed.

According to one embodiment of the Road Condition Monitoring System, a vehicle has a traffic light preemption system with a GPS receiver and an Inertial Measurement Unit (IMU). At least one processor is configured to log GPS data in correlation with IMU data, and to detect and map road surface defects. The at least one processor is further configured to detect and monitor changes in the IMU data associated with a given road surface defect.

According to another embodiment of the Road Condition Monitoring System, at least one processor is configured to log GPS data in correlation with IMU data, and to detect and map road surface defects, in a vehicle having a traffic light preemption system with a GPS receiver and an IMU. The at least one processor is further configured to detect and monitor changes in the IMU data associated with a given road surface defect.

According to another embodiment of the Road Condition Monitoring System, a method of monitoring the condition of roads using a vehicle having a traffic light preemption system with a GPS receiver and an IMU includes several steps. The first step is configuring at least one processor to log GPS data in correlation with IMU data. The second step is using the GPS data and the IMU data to detect and map road surface defects. The third step is further configuring the at least one processor to detect and monitor changes in the IMU data associated with a given road surface defect.

Embodiments of the Road Condition Monitoring System allow emergency vehicles, which almost continually drive the roads in an area, to continue to gather data. Generally, this equates to more and better confirmed data. For instance, if a pothole is avoided by a vehicle on the first traversal of a given route because it does not stretch across the entire road or across all vehicle lanes, it may be encountered on a second traversal of the route.

### DESCRIPTION OF THE DRAWINGS

The above-mentioned and other features of embodiments of the Road Condition Monitoring System, and the manner of their working, will become more apparent and will be better understood by reference to the following description of embodiments of the Road Condition Monitoring System taken in conjunction with the accompanying drawings, wherein:

FIG. 1 is a table showing IMU data recorded by an embodiment of the Road Condition Monitoring System of the present invention, as described herein;

FIG. 2 is a screenshot of an embodiment of a mapping application as used in conjunction with the Road Condition Monitoring System of the present invention, as described herein;

FIG. 3 is a screenshot of a road surface having an event that may be logged by an embodiment of the Road Condition Monitoring System of the present invention, as described herein;

FIG. 4 is a screenshot of an embodiment the Road Condition Monitoring System of the present invention, as described herein; and

FIG. 5 is a screenshot of an embodiment the Road Condition Monitoring System of the present invention, as described herein.

Corresponding reference numbers indicate corresponding parts throughout the several views. The exemplifications set out herein illustrate embodiments of the Road Condition Monitoring System, and such exemplifications are not to be construed as limiting the scope of the claims in any manner.

### DETAILED DESCRIPTION

The following detailed description and appended drawing describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

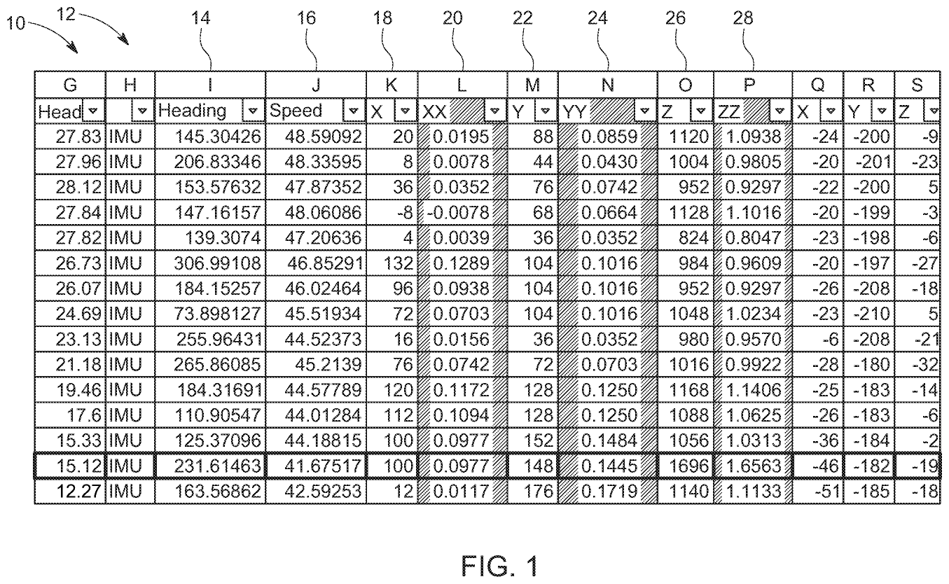

Turning now to FIG. 1, a table having IMU data 12 recorded by an embodiment of the Road Condition Monitoring System 10 of the present invention is shown. Compass heading 14 is given in Column I and speed 16 is given in Column J. X axis IMU data (header X) 18 is given in Column K, Y axis IMU data (header Y) 22 is given in Column M, and Z axis IMU data (header Z) 26 is given in Column O. In the present embodiment, each of these raw IMU data are divided by 1024 according to the specifications of the IMU to give X axis real value (header XX) 20 in Column L, Y axis real value (header YY) 24 in Column N, and Z axis real value (header ZZ) 28 in Column P. In another embodiment, each of the X axis real value 20, the Y axis real value 24, and the Z axis real value 28 may be squared by the at least one processor. These squared values may then be summed, and the square root of the sum taken, in order to find an absolute value of the magnitude of the acceleration. Further data may include latitude and longitude (not shown). In the highlighted row it is noted that the Z axis real value 28 jumps to greater than 1.65, indicating a bump in the road. It is further noted that the bump indicated in the highlighted row was not preceded or followed by a substantial decrease. For the purpose of the embodiment of the Road Condition Monitoring System 10 shown in FIG. 1, generally any Z axis real value 28 below 0.8 or above 1.2 may be considered a significant event. Any Z axis real value 28 in the 1.6 range or higher may be considered a serious event, and any Z axis real value 28 below 0.4 may be considered a serious event.

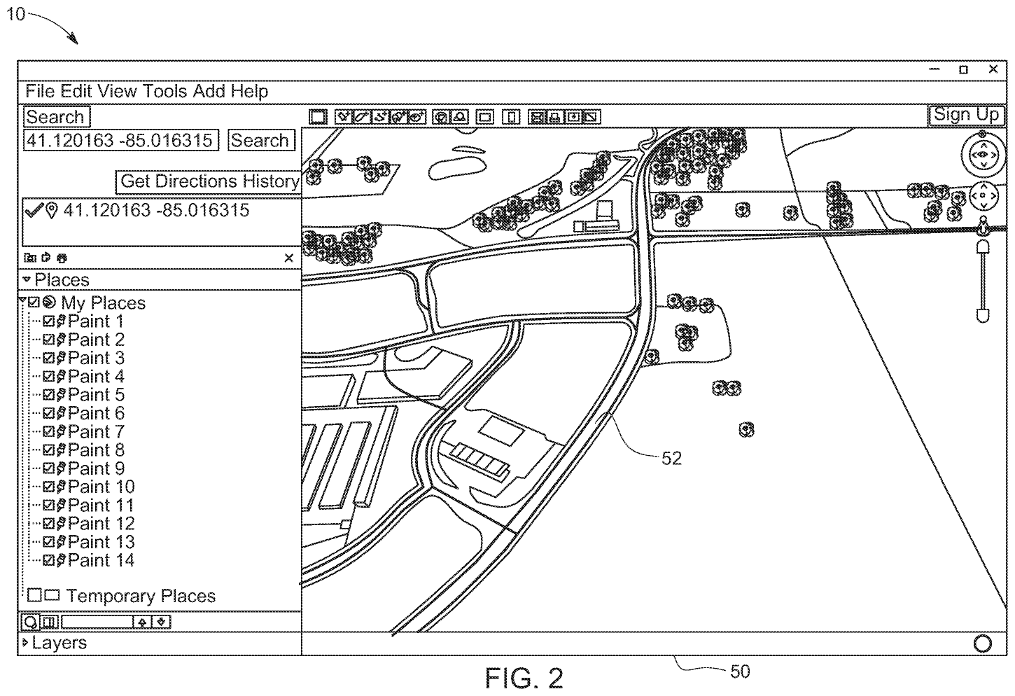

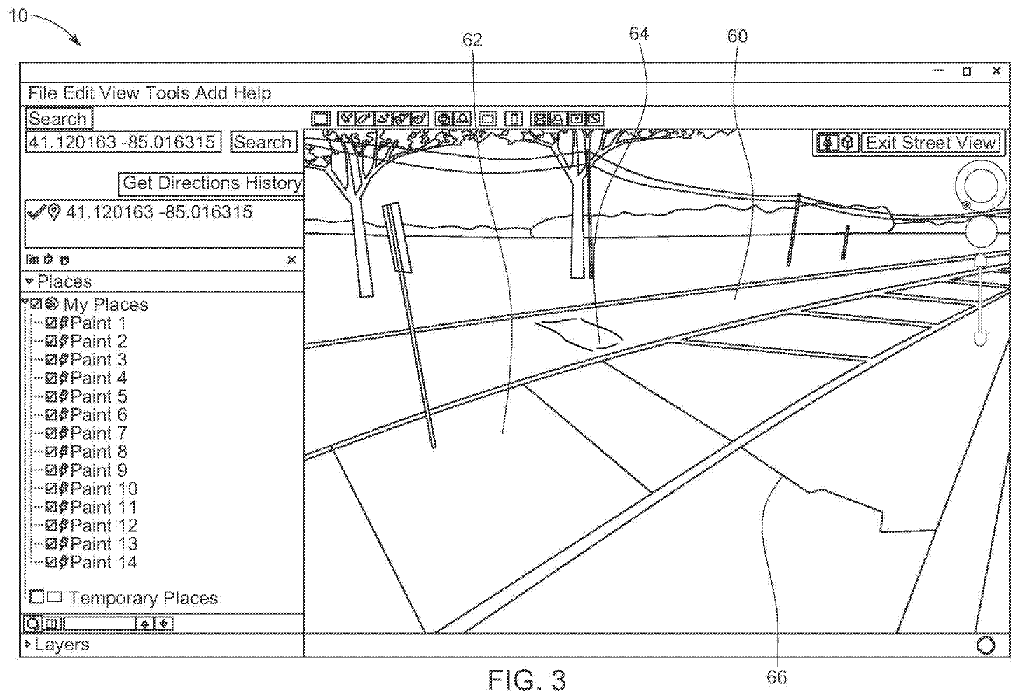

FIG. 2 shows a screenshot of an embodiment of a mapping application as used in conjunction with the Road Condition Monitoring System 10 of the present invention. A map of the reading area 50 is displayed, including the roads 52 to be traversed by a vehicle having an embodiment of the Road Condition Monitoring System 10. Similarly, FIG. 3 displays a road 60 having a median 62, as well as a bump in road 64, and a change in elevation 66, which may be logged by an embodiment of the Road Condition Monitoring System 10.

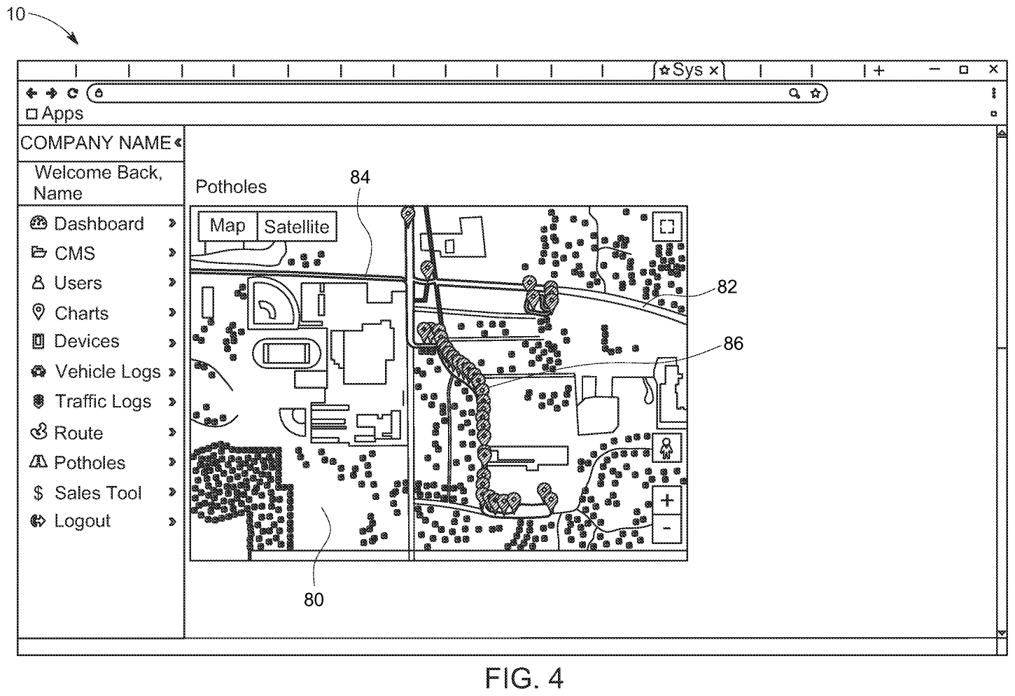

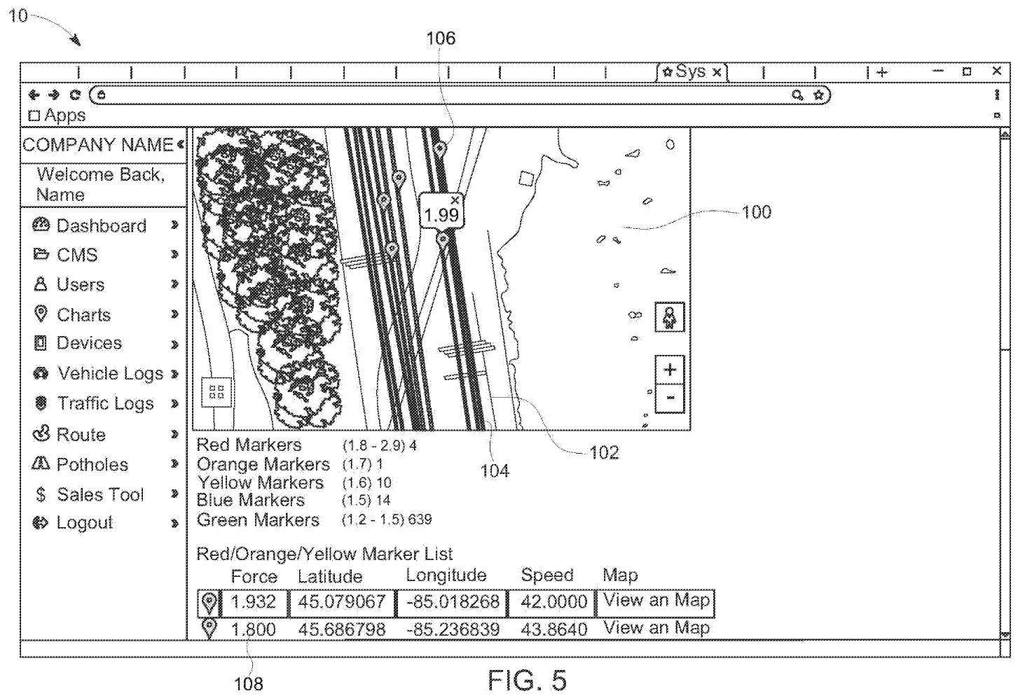

FIGS. 4 and 5 show screenshots of embodiments of the Road Condition Monitoring System 10. In FIG. 4, a data map 80 is displayed showing roads 82 over which an emergency vehicle runs a route 84. As the emergency vehicle runs the route 84, the Road Condition Monitoring System 10 logs events 86 corresponding to potholes, bumps, cracks, and other anomalies. Similarly, in FIG. 5, a data map 100 is displayed showing roads 102 over which an emergency vehicle runs a route 104. As the emergency vehicle runs the route 104, the Road Condition Monitoring System 10 logs events 106 corresponding to potholes, bumps, cracks, and other anomalies. In the embodiment of the Road Condition Monitoring System 10 shown in FIG. 5, the events are shown sorted and classified at 108. The sorted and classified events 108 are shown along with their severity, location longitude and latitude, and the vehicle speed when encountering the event. A “View on Map” button may be provided that allows a user to locate the events 106 on the data map 100 that correspond to the sorted and classified events 108. A color coding may be provided along with the events 106 shown on the data map 100. In the embodiment of the Road Condition Monitoring System 10 shown in FIG. 5, red markers indicating events 106 represent Z axis real values of between 1.8 and 2.9, orange markers represent Z axis real values of 1.7, yellow markers represent Z axis real values of 1.6, blue markers represent Z axis real values of 1.5, and green markers represent Z axis real values of between 1.2 and 1.5.

While the Road Condition Monitoring System has been described with respect to at least one embodiment, the Road Condition Monitoring System can be further modified within the spirit and scope of this disclosure, as demonstrated previously. This application is therefore intended to cover any variations, uses, or adaptations of the Road Condition Monitoring System using its general principles. Further, this application is intended to cover such departures from the present disclosure as come within known or customary practice in the art to which the disclosure pertains and which fall within the limits of the appended claims.

### REFERENCE NUMBER LISTING

10 Road condition monitoring system
12 IMU data
14 Compass heading
16 Speed
18 X axis IMU data (col X)
20 X axis real value (col XX)
22 Y axis IMU data (col Y)
24 Y axis real value (col YY)
26 Z axis IMU data (col Z)
28 Z axis real value (col ZZ)
50 Map of reading area (FIG. 2)
52 Roads
60 Road (FIG. 3)
62 Median
64 Bump in road
66 Change in elevation
80 Data map (FIG. 4)
82 Roads
84 Vehicle route
86 Events
100 Data map (FIG. 5)
102 Roads
104 Vehicle route
106 Events
108 Events, sorted and classified

What is claimed is:

1. A vehicle having a Road Condition Monitoring System, comprising:
a traffic light preemption system having a GPS receiver and an Inertial Measurement Unit (IMU);
at least one processor configured to log GPS data in correlation with IMU data, and to detect and map road surface defects; and
the at least one processor being further configured to detect and monitor changes in the IMU data associated with a given road surface defect.

2. The vehicle of claim 1, wherein:
the at least one processor being further configured to identify and report unmapped roads.

3. The vehicle of claim 1, wherein:
the at least one processor being further configured to correlate changes in the road surface defects with at least one of traffic load, road construction type, and an environmental factor.

4. The vehicle of claim 1, wherein:
the at least one processor being further configured to detect and monitor road surface changes and to predict the development of road surface defects using at least one of industry data concerning road construction, industry data concerning road deterioration, and specific local data concerning road construction and/or deterioration.

5. The vehicle of claim 4, wherein:
the at least one processor being further configured to at least one of map predicted road surface defects and predict at least one characteristic of the predicted road surface defect.

6. The vehicle of claim 1, wherein:
the at least one processor being further configured to monitor repairs to road surface defects.

7. The vehicle of claim 6, wherein:
the at least one processor being further configured to correlate the effectiveness of repairs to road surface defects with at least one of traffic load, road construction type, repair type, repairing entity, and an environmental factor.

8. The vehicle of claim 6, wherein:
the at least one processor being further configured to track the settling of an overfill type of road surface defect repair.

9. The vehicle of claim 1, wherein:
the at least one processor being further configured to determine which roads have the highest frequency and/or severity of road surface defects;
the at least one processor being further configured to accept at least one input including at least one of:
a total repair budget,
a cost per length to repave a road or a lane of a road,
a cost per pothole for manual repair,
traffic estimates for a road; and
the at least one processor being further configured to calculate at least one cost and to recommend at least one possible repair strategy.

10. A Road Condition Monitoring System for use with a vehicle having a traffic light preemption system having a GPS receiver and an IMU, comprising:
at least one processor configured to log GPS data in correlation with IMU data, and to detect and map road surface defects, the at least one processor being further configured to detect and monitor changes in the IMU data associated with a given road surface defect.

11. The Road Condition Monitoring System of claim 10, wherein:
the at least one processor being further configured to identify and report unmapped roads.

12. The Road Condition Monitoring System of claim 10, wherein:
the at least one processor being further configured to correlate changes in the road surface defects with at least one of traffic load, road construction type, and an environmental factor.

13. The Road Condition Monitoring System of claim 10, wherein:
the at least one processor being further configured to detect and monitor road surface changes and to predict the development of road surface defects using at least one of industry data concerning road construction, industry data concerning road deterioration, and specific local data concerning road construction and/or deterioration.

14. The Road Condition Monitoring System of claim 10, wherein:
the at least one processor being further configured to at least one of map predicted road surface defects and predict at least one characteristic of the predicted road surface defect.

15. The Road Condition Monitoring System of claim 10, wherein:
the at least one processor being further configured to monitor repairs to road surface defects.

16. The Road Condition Monitoring System of claim 15, wherein:
the at least one processor being further configured to correlate the effectiveness of repairs to road surface defects with at least one of traffic load, road construction type, repair type, repairing entity, and an environmental factor.

17. The Road Condition Monitoring System of claim 15, wherein:
the at least one processor being further configured to track the settling of an overfill type of road surface defect repair.

18. The Road Condition Monitoring System of claim 10, wherein:
the at least one processor being further configured to determine which roads have the highest frequency and/or severity of road surface defects;
the at least one processor being further configured to accept at least one input including at least one of:
a total repair budget,
a cost per length to repave a road or a lane of a road,
a cost per pothole for manual repair,
traffic estimates for a road; and
the at least one processor being further configured to calculate at least one cost and to recommend at least one possible repair strategy.

19. A method of monitoring the condition of roads using a vehicle having a traffic light preemption system having a GPS receiver and an IMU, comprising the steps of:
configuring at least one processor to log GPS data in correlation with IMU data, and to detect and map road surface defects; and
configuring the at least one processor to detect and monitor changes in the IMU data associated with a given road surface defect.

20. The method of claim 19, further comprising the step of:
configuring the at least one processor to identify and report unmapped roads.

21. The method of claim 19, further comprising the step of:
configuring the at least one processor to correlate changes in the road surface defects with at least one of traffic load, road construction type, and an environmental factor.

22. The method of claim 19, further comprising the step of:
configuring the at least one processor to detect and monitor road surface changes and to predict the development of road surface defects using at least one of industry data concerning road construction, industry data concerning road deterioration, and specific local data concerning road construction and/or deterioration.

23. The method of claim 19, further comprising the step of:
configuring the at least one processor to at least one of map predicted road surface defects and predict at least one characteristic of the predicted road surface defect.

24. The method of claim 19, further comprising the step of:
configuring the at least one processor to monitor repairs to road surface defects.

25. The method of claim 24, further comprising the step of:
configuring the at least one processor to correlate the effectiveness of repairs to road surface defects with at least one of traffic load, road construction type, repair type, repairing entity, and an environmental factor.

26. The method of claim 24, further comprising the step of:
configuring the at least one processor to track the settling of an overfill type of road surface defect repair.

27. The method of claim 19, further comprising the step of:
configuring the at least one processor to determine which roads have the highest frequency and/or severity of road surface defects;
configuring the at least one processor to accept at least one input including at least one of:
a total repair budget,
a cost per length to repave a road or a lane of a road,
a cost per pothole for manual repair,
traffic estimates for a road; and
configuring the at least one processor to calculate at least one cost and to recommend at least one possible repair strategy.
